(19) United States
(12) Patent Application Publication
(10) Pub. No.: US 2001/0031623 A1
(43) Pub. Date: Oct. 18, 2001

(54) Channel booster amplifier

(76) Inventor: Lee Masoian, West New York, NJ (US)

Correspondence Address: Alexander B. Ching, Quarles & Brady Streich Lang LLP, Renaissance One, Two North Central Avenue, Phoenix, AZ, 85004, US

(21) Appl. No.: 09/799,155

(22) Filed: Mar. 5, 2001

Related U.S. Application Data
(60) Provisional application No. 60/187,940, filed on Mar. 3, 2000.

(51) Int. Cl. H04B 7/15

(52) U.S. Cl. 455/11.1; 455/15; 455/22; 455/571

(57) ABSTRACT

An improved filter amplifier for wireless communication is provided. The filter amplifier comprises a talk-in and talk-out booster. The booster utilizes a single local oscillator to down-convert a received signal for filtering and up-convert the received signal for further amplification. A combining unit including amplifier and isolator is operable to receive the filtered signal and amplify and combine the signal. The use of isolators allows for combining signals without interference. The booster amplifier filter unit is designed for use in low reception areas including tunnels and office buildings.

### TECHNICAL FIELD OF THE INVENTION

This invention relates to the amplification of wireless communication signals, and more specifically to an improved channel booster amplifier.

### BACKGROUND

In recent years, the uses of wireless communications methods have exploded. These include the use of cellular telephones, pagers, trunking radios and other such systems. While these systems are increasingly more reliable and easy to use, there are still many areas where the coverage of wireless communications systems fail. These include the interior of buildings, the inside of tunnels, and other areas where wireless communications signals cannot penetrate reliably. Various techniques have been employed to try to enhance communications inside of buildings and tunnels and other areas where wireless communications fail. However, these attempts have met with mixed success because they are often bulky and unable to adapt to a wide range of communication needs. What is needed is a compact and efficient way of filtering and boosting wireless communication signals such that they can be used in areas where coverage is not optimal.

### SUMMARY OF THE INVENTION

Accordingly, it may be appreciated that a need has arisen for an improved channel booster amplifier for wireless communications. In accordance with the teachings of the present invention, an improved channel booster amplifier is provided that substantially eliminates or reduces the disadvantages and problems associated with conventional devices.

In one embodiment an improved filter amplifier for wireless communication is provided. The filter amplifier comprises a talk-in and talk-out booster. The booster utilizes a single local oscillator to down-convert a received signal for filtering and up-convert the received signal for further amplification. A combining unit including amplifier and isolator is operable to receive the filtered signal and amplify and combine the signal. The use of isolators allows for combining signals without interference. The booster amplifier filter unit is designed for use in low reception areas including tunnels and office buildings.

The present invention provides various technical advantages over conventional filters. For example, the present invention provides isolation between amplification and combining of signals thus reducing signal loss through interference. Second, the filter and booster of the present invention uses easy to use cards which can be used in either the talk-in or talk-out direction. Other technical advantages will be readily apparent to one skilled in the art from the following figures, descriptions, and claims.

### BRIEF DESCRIPTION OF THE DRAWINGS

For a more complete understanding of the present invention and the advantages thereof, reference is made to the following descriptions taken in conjunction with the following figures, in which like reference materials represent like parts and in which:

FIG. 1 illustrates a communication system in accordance with the teachings of the present invention;

FIG. 2 illustrates a booster/amplifier in accordance with the teachings of the present invention;

FIGS. 3a and 3b illustrate the components of the booster and amplifier in accordance with the teachings of the present invention;

FIG. 4 illustrates the combiner and associated amplifiers in accordance with the teachings of the present invention;

FIG. 5 illustrates a band pass filter in accordance with the teachings of the present invention; and,

FIG. 6 illustrates signal strength adjustment system in accordance with the teachings of the present invention.

### DETAILED DESCRIPTION OF THE INVENTION

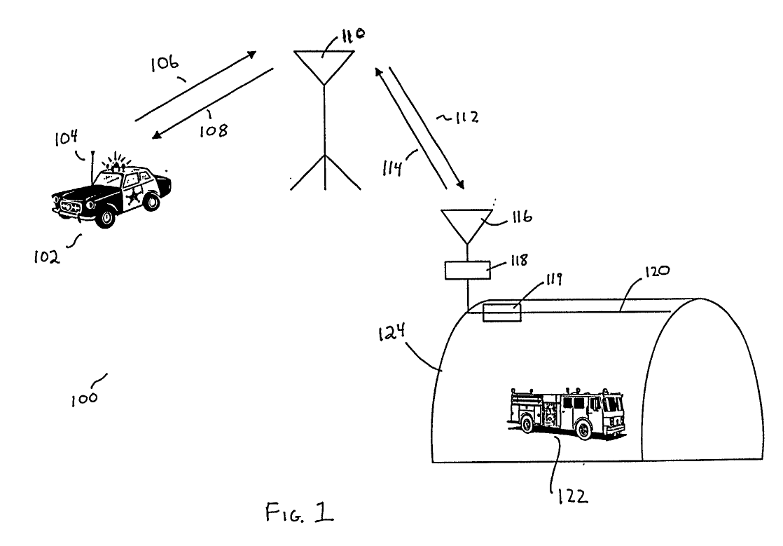

FIG. 1 is a block diagram of a wireless communication system 100 in accordance with the teaching of the present invention. The present invention is not to be limited to such an illustration; however, the illustration is instructive for purposes of invention discussion. To those skilled in the art it is known that such a communication system can be adapted to many different uses. In FIG. 1 is a communication system 100. In one embodiment, communication system 100 is a trunking radio system used by municipalities to communicate between emergency vehicles. In this system, a first vehicle 102 with antenna 104 receives and sends communications to a second vehicle 122. The communication can be transferred through one or more antenna systems 110. In this system, each vehicle uses one channel to transmit communication signals and a second channel to receive communication signals. Communication signal 106 is the communication signal between first vehicle 102 and antenna 110. Communication relayed by antenna 110 to first vehicle 102 is communication signal 108. In FIG. 1, second vehicle 122 is inside a tunnel. Normally, second vehicle 122 would not be able to receive the communication from first vehicle 102 because the tunnel blocks the signals. To help this situation, an antenna 116 is mounted outside tunnel 124. Included downstream from the antenna is a band pass filter 118. The band pass filter 118 is coupled to booster amplifier 119, which is coupled to one or more radiating cables 120 that run inside the tunnel. Radiating cable 120 is essentially a long cable antenna. System 100 operates as a fully duplex system supporting both incoming and outgoing communications.

In operation, first vehicle 102 sends a communication signal to second vehicle 122. The communication signal is transmitted from first vehicle 102 as communication signal 106 and is relayed by antenna 110 to antenna 116 as communication signal 112. Antenna 116 receives communication signal 112 and sends it to band pass filter 118, which filters out any frequency outside the expected range of received communication. Then the communication signal is passed to booster amplifier 119 where the signal is filtered and boosted sufficiently to be sent over radiating cable 120. As the signal is sent over radiating cable 120, second vehicle 122 receives the signal. Also, second vehicle 122 can transmit a communication signal by broadcasting to radiating cable 120 through booster amplifier 119, through band pass filter 118 to which filters out signals outside the expected transmittal range. The filtered communication is sent to antenna 116. Antenna 116 broadcasts communication signal 114 to antenna 110. Antenna 110 broadcasts the communication signal where it is received by first vehicle 102 as communication signal 108 at antenna 104. Such actions can then occur back and forth as necessary. Antenna 110 is not always needed. The necessity of antenna 110 depends on the location of first vehicle 102 and the strength of the transmitted signal. In some embodiments, first vehicle 102 directly communicates with antenna 116. In a typical trunking radio system, there are separate channels for receiving and transmitting. Typically, there are 8 channels for receiving and 8 channels for transmitting. An individual is assigned a certain transmit and receive set.

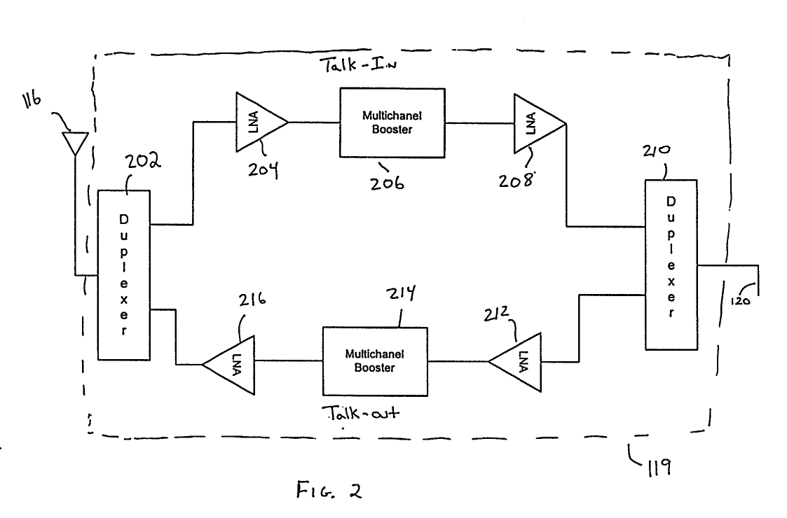

FIG. 2 is a block diagram of booster amplifier 119 with antenna in accordance with the teachings of the present invention. Illustrated is antenna 116 that is coupled to a duplexer 202. Duplexer 202 sends signals received by antenna 116 to low noise amplifier band pass filter 204 which is coupled to a talk-in booster 206 which filters and amplifies the communication signal. Talk-in booster 206 is coupled to a second low noise amplifier unit 208. Low noise amplifier unit 208 couples to a second duplexer 210 which has as one output the radiating cable 120. Signals received from second low noise amplifier unit 208 are sent over radiating cable 120 which is typically placed in a tunnel or the like. Duplexer 210 also is coupled to a low noise amplifier band pass filter that is operable to receive signals from radiating cable 120 and duplexer 210. Low noise amplifier unit 212 is coupled to a talk-out multi-channel booster 214 which in turn is connected to low noise amplifier unit 216 which is coupled to first duplexer 202 which in turn couples to antenna 116.

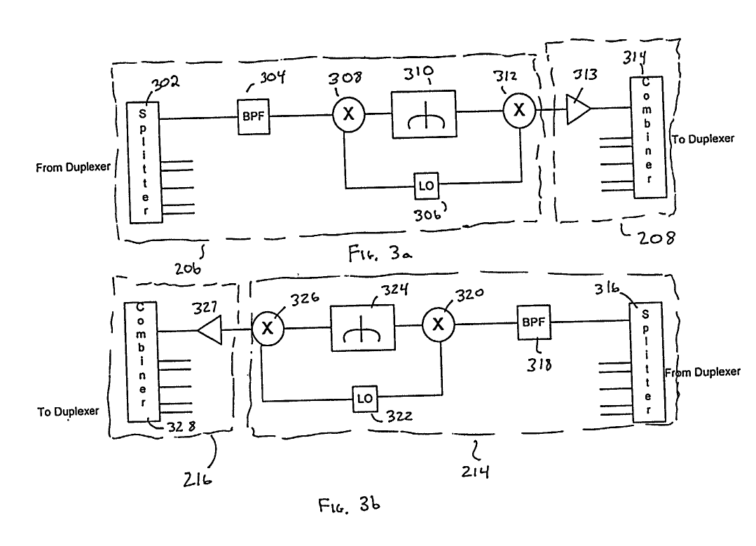

In operation, communication signals received by antenna 116 are sent to duplexer 202 where they are then relayed to the talk-in side of booster amplifier 200. The communication signals are amplified and band pass filtered to clean up the communication signal at low noise amplifier band pass filter 204. Next, multi-channel booster filter 206 filters and boosts the communication signal. The filtering and boosting is done in an intermediate frequency range that requires talk-in booster 206 to include means for down converting the radio frequency signal to an intermediate frequency signal. This will be described in further detail in conjunction with FIG. 3a. The output of talk-in booster 206 will be a radio frequency signal that will then be boosted by low noise amplifier 208 and sent to duplexer 210 to be routed to radiating cable 120 for transmitting to cars or personnel inside of a tunnel, building or other areas where wireless communications fails. The operation of talk-out side is for most purposes similar. A signal is sent from inside the tunnel to cable 120 which inputs to duplexer 210 which will then send the communication signal to low noise amplifier band pass filter 212 for filtering and amplification. That signal is then sent to talk-out booster amplifier 214 where it is both boosted and amplified in an intermediate frequency and then converted back to a radio frequency signal for boosting by low noise amplifier 216. The signal is then sent to duplexer 202 where it is routed to antenna 116 for communication outside the tunnel.

FIG. 3a illustrates in more detail talk-in booster 206 and amplifier 208. Talk-in booster 206 includes a splitter 302 that is coupled to band pass filter 304 that in turn is coupled to a mixer 308. Mixer 308 is coupled to a local oscillator 306 as well as a crystal filter 310. The output of crystal filter 310 is then supplied to a second mixer 312 that is also coupled to local oscillator 306. Second mixer 312 outputs to amplifier 313 that then outputs to combiner 314. The output of combiner 314 is to duplexer 210.

In operation, a communication signal is received from duplexer 202 via antenna 106. In one embodiment, the communication signal may comprise one or more communication channels. If that is so, splitter 302 will split out the communication signal into one or more different communication channels. All processing between splitter 302 and combiner 314 is identical for each signal. Therefore, the discussion of one signal will suffice for discussion of all signals. In a typical trunking radio system, eight (8) signals are outputted from the splitter 302. Each channel will then output to band pass filter 304 where it is filtered within a narrow range. Then, mixer 308 will mix the signal from the band pass filter with the signal from the local oscillator. This will down convert the signal to an intermediate frequency range. When the signal is in the intermediate frequency range, it is then filtered by crystal filter 310. After filtering, the second mixer again mixes the intermediate frequency signal with the signal from local oscillator 306 in order to convert it back to the original frequency. By providing a single local oscillator 306, to run both mixers 308 and 312, any error in the local oscillator is compensated for. Thus, there is no frequency drift. The local oscillator is synthesizer controlled and programmable. This allows for changes in the frequency of the local oscillator. This provides technical advantages over systems that use multiple local oscillators to control one or more mixers. Also, by converting to an intermediate frequency mode before filtering helps increase the efficiency of the filtering. The signal is then sent to an amplifier where it is then amplified by amplifier 313 and then all the different signals are combined together by combiner 314 and sent to duplexer 208.

FIG. 3b illustrates the same system as FIG. 3a except on the talk-out side. In this example, talk-out booster 214 is illustrated. A signal from duplexer 310 is received by splitter 316 to be split into the number of signals necessary. The signal is then filtered by band pass filter 318 and converted to an intermediate frequency by mixer 320 and is then filtered by crystal filter 324 and mixed by mixer 326 back to the original frequency. One local oscillator 322 provides a signal to both first and second mixers 320 and 326. The signal is then amplified by an amplifier 327 and combined by combiner 328 to be sent to duplexer 202 for sending over antenna 116. Again, the use of a single local oscillator compensates for an error in the oscillator is an advantage. If there is an error in local oscillator it is repeated in both mixers so it is compensated for. Also, one local oscillator reduces cost and size of necessary components. Secondly, by having similar components in both the talk-in and talk-out directions, the circuitry for the booster can be integrated in a single card that can be easily used and re-used in the system of the present invention. Finally, the output of talk-in booster 206 and talk-out booster 214 are the same for each channel, regardless of the input signal.

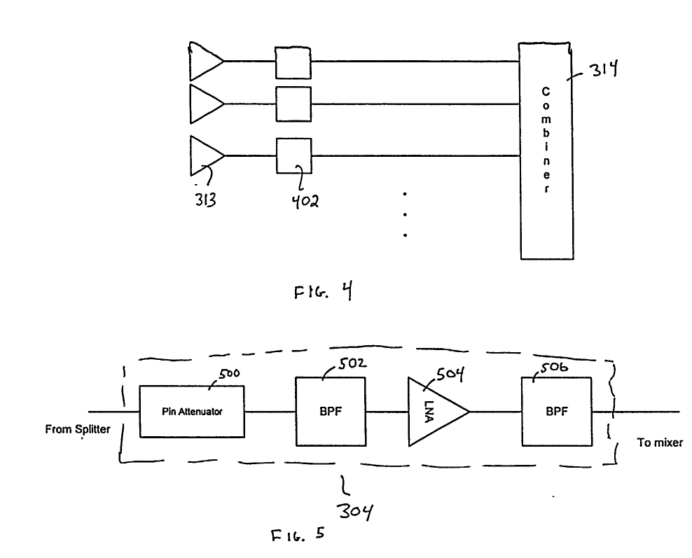

FIG. 4 illustrates the combiner in accordance with the teaching of the present invention. FIG. 4 illustrates combiner 314 although the same information would also be applicable to combiner 328. Illustrated is an amplifier 313 coupled to an isolator 402. The amplifier-isolator pair are reproduced for as many signals that are input to combiner 314. Amplifier 313 receives a signal from second mixer 312 and amplifies that signal which will then go through an isolator that helps to reduce interference between the signals entering into combiner 314. In the absence of isolator 402, the signals for each of the different frequencies tend to interfere with each other and create intermodulations between the signals making the communication difficult to receive. If the signals are first combined and then amplified the required amplifier would be a very high power amplifier. The use of an amplifier for each channel allows a lower power amplifier to be used saving power and reducing thermal problems. The providing of isolator 402 between the amplifier 313 and the combiner 314 increases the isolation between each input into the combiner 314 and prevents interference between adjacent signals.

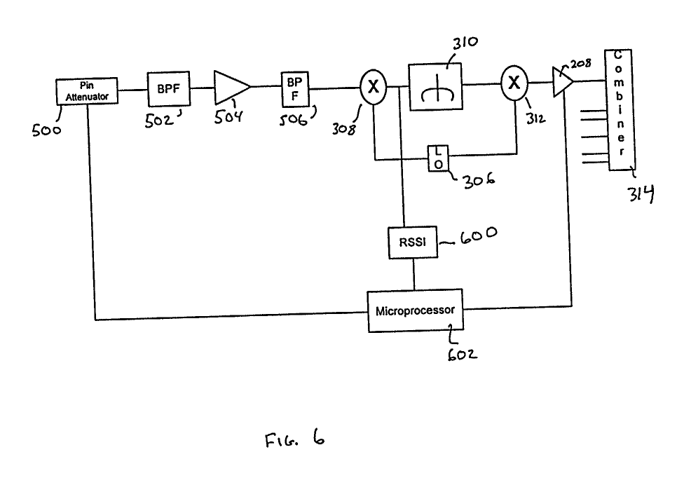

FIG. 5 illustrates band pass filter 304 in accordance with the teachings of the present invention. This information would also apply to band pass filter 318. A pin attenuator 500 receives a signal from splitter 302. The pin attenuator 500 attenuates and sends the signal to band pass filter 502 which filters and then sends the signal to low noise amplifier 504 for amplification. The signal is sent to a second filtering stage 506 for filtering before sending to the first mixer 308.

In operation, the communication signal from the signal goes to pin attenuator 500 in order to attenuate the signal. The amount of attenuation depends upon a number of factors and is done to avoid too much gain in the system. The signal is then band pass filtered by band pass filter 502 and amplified to some extent by low noise amplifier 504. Finally, the signal is again band pass filtered to remove any signals outside the expected received range and the signal is sent to mixer 308.

FIG. 6 illustrates an attenuation and amplification adjustment system in accordance with the teachings of the present invention. Illustrated is pin attenuator 500 coupled to band pass filter 502, low noise amplifier 504 and second filtering stage 506, as discussed in FIG. 5. First mixer 308 couples to crystal filter 310 and second mixer 312, which in turn couples to power amplifier 208. All of these components have been previously discussed. In this embodiment, a received signal strength indicator (RSSI) 600 is coupled between first mixer 308 and second mixer 312. RSSI measures the strength of the received signal and sends this information to microprocessor 602. Microprocessor 602 then compares the received signal strength to predetermined thresholds. If the signal strength is below a certain first threshold, it is assumed no signal is received and any amplification is turned off at low noise amplifier unit 208 to conserve power. When the signal strength meets or exceeds the first threshold, amplification is activated. If the signal strength is higher then a second threshold, pin attenuator 500 can be used to attenuate the received signal. If this was not done, distortion of the received signal could occur. Microprocessor 602 is also operable to control the settings of local oscillator 306 to adjust local oscillator 306 to the correct frequency for the channel to be filtered.

While the invention has been particularly shown and described in the foregoing detailed description, it will be understood by those skilled in the art that various other changes in form and detail may be made without departing from the spirit and scope of the invention.

What is claimed is:

1. A booster filter apparatus comprising:
a first duplexer operable to receive a first signal;
a talk-in booster operable to down-convert the first signal from the first duplexer to an intermediate frequency signal, to filter the intermediate frequency signal, and to up-convert the intermediate frequency signal to a first radio frequency signal;
a second duplexer coupled to the booster and operable to receive and output the first radio frequency signal from the talk-in booster, and to receive a second signal; and
a talk-out booster operable to down convert the second signal from second duplexer, to filter the down converted signal, to up convert the down converted signal to a second radio frequency signal and to output the second radio frequency signal to the first duplexer.

2. The apparatus of claim 1, wherein a single local oscillator is used in the talk-in booster and the talk-out booster.

3. The apparatus of claim 2, wherein the local oscillator is programmable.

4. The apparatus of claim 1, wherein the first radio frequency signal is sent to a radiating cable and the second signal is received by the radiating cable.

5. The apparatus of claim 1, further comprising a first power amplifier coupled between the talk-in booster and the second duplexer and a second power amplifier located between the talk-out booster and the first duplexer.

6. The apparatus of claim 1, wherein the first signal comprises multiple communication channels.

7. The apparatus of claim 6, wherein a splitter is coupled to the talk-in booster and the splitter splits the first signal into multiple channels prior to being received by the talk-in booster and wherein there is a talk-in booster for each channel.

8. The apparatus of claim 7, wherein the channels are combined prior to sending to the second duplexer.

9. The apparatus of claim 7, wherein a power amplifier and isolator amplifies and isolates each channelized signal prior to combining the signals.

10. The apparatus of claim 1, further comprising a received signal strength indicator and a microprocessor coupled to the talk-in booster and a second received signal strength indicator and a second microprocessor, coupled to the talk-out booster, the received signal strength indicators operable to measure the strength of received signals and present it to the microprocessor.

11. The apparatus of claim 10, wherein the microprocessor is operable to control the attenuation and amplification of a received signal.

12. A system for wireless communication comprising:
a first wireless transceiver;
a second wireless transceiver operating in an area;
a communication platform coupling the first wireless transceiver and the second wireless transceiver wherein the communication platform is operable to filter and boost the signal from between the first wireless transceiver and the second wireless transceiver, and further wherein the second wireless transceiver is located in an area of poor wireless communication reception and communicates with the communication platform via a radiating cable.

13. The system of claim 12, wherein the communication platform comprises a talk-in booster and a talk-out booster.

14. The system of claim 13, wherein a single local oscillator is used in the talk-in booster and the talk-out booster.

15. The system of claim 14, wherein the local oscillator is programmable.

16. The system of claim 13, further comprising a first power amplifier coupled between the talk-in booster and a second duplexer and a second power amplifier located between the talk-out booster and a first duplexer.

17. The system of claim 12, wherein the wireless communication comprises multiple communication channels.

18. The system of claim 17, wherein there is a talk-in booster and a talk-out booster for each communication channel

19. The system of claim 17, wherein the channels are combined prior to sending to the second duplexer.

20. The system of claim 19, wherein a power amplifier and isolator amplifies and isolates each channelized signal prior to combining the channels.

21. The system of claim 14, further comprising a received signal strength indicator and a microprocessor coupled to the talk-in booster and a second received signal strength indicator and a second microprocessor coupled to the talk-out booster, the received signal strength indicators operable to measure the strength of received signals and present it to the microprocessor.

22. The system of claim 21, wherein the microprocessor is operable to control the attenuation and amplification of a received signal.

23. The system of claim 21, wherein the microprocessor is operable to program the local oscillator.

24. A wireless communication channelized booster amplifier comprising:
a first antenna operable to receive a first communication signal;
a first duplexer operable to route the first communication signal to a talk-in side of the amplifier;
a first splitter operable to split the first signal into one or more channels;
a plurality of first boosters, each operable to receive a channel signal, down convert the channel signal, filter the signal and up convert the signal;
a plurality of power amplifiers and isolators operable to amplify the signal and provide signal isolation prior to combining the channelized signals;
a first combiner operable to combine the channelized signal;
a second duplexer operable to receive the combined signal from the first combiner and send the signal out over a radiating cable, the second duplexer also operable to receive a second communication signal from the radiating cable;
a second splitter operable to channelize the second communication signal into one or more channel signals;
a plurality of second boosters, each operable to receive the channel signal, down convert the channel signal, filter the channel signal and up convert the channel signal;
a plurality of power amplifiers and isolators operable to amplify the channel signal and provide signal isolation prior to combining the channel signal; and
a second combiner operable to combine the channel signals and present them to the first duplexer.

25. The amplifier of claim 24, wherein the first booster and second booster include a first mixer coupled to a filter and the filter coupled to a second mixer, the first and second mixer coupled to a common local oscillator.

26. The amplifier of claim 25, wherein a received signal strength indicator is coupled between the first and second mixer.

27. The amplifier of claim 26, wherein a microprocessor is coupled to the received signal strength indicator, the microprocessor further coupled to an attennuator and the power amplifier, the microprocessor operable to control the attennuator and power amplifier based on the output of the received signal strength indicator.
